(19) United States
(12) Patent Application Publication
(10) Pub. No.: US 2011/0153401 A1
(43) Pub. Date: Jun. 23, 2011

(54) TESTING THE VALIDITY OF ELECTRONIC COUPON CODES

(75) Inventors: Bart Jellema, Haymarket (AU); Herman Bosma, Chippendale (AU); Gary Robert Brewer, Manly (AU); Mark William Roger Bradley, Sydney (AU)

(73) Assignee: INTERNET BRANDS, INC., El Segundo, CA (US)

(21) Appl. No.: 12/860,886

(22) Filed: Aug. 21, 2010

(30) Foreign Application Priority Data
Dec. 17, 2009 (AU) 2009906112
Apr. 1, 2010 (AU) 2010100229

(51) Int. Cl. G06Q 30/00

(52) U.S. Cl. 705/14.26

(57) ABSTRACT

A system and computer program product for testing the validity of coupon codes. Coupon codes can be automatically tested, instead of manually testing them, by having a program select one or more products on a merchant's website and then add them to the shopping cart on the merchant's website. Upon entering the checkout stage on the merchant's website, the program can submit the coupon code to be tested at the checkout stage. The validity of the coupon code is determined based on the status of the coupon code (e.g., expired, approved advertised benefit) returned by the merchant's website. By having a program automatically test coupon codes instead of having a user manually test each coupon code, the validity of coupons code can be more accurately determined in a more efficient manner.

### CROSS-REFERENCE TO RELATED APPLICATIONS

This application claims priority from Australian Provisional Application No. 2009906112, entitled “Tool, Method and System for Activation of Redemption-Value,” filed on Dec. 17, 2009, the contents of which are incorporated herein by reference. Furthermore, this application claims priority from Australian Innovation Patent Application No. 2010100229, entitled “Tool, Method and System for Testing of a Redemption-Value Activator,” filed on Apr. 1, 2010, the contents of which are incorporated herein by reference.

### TECHNICAL FIELD

The present invention relates to electronic coupon codes, and more particularly to testing the validity of electronic coupon codes.

### BACKGROUND OF THE INVENTION

Online retainers may use coupons to encourage consumers to purchase specific products or to purchase from specific retailers. These Internet coupons may be referred to as “coupon codes.” “Coupon codes,” as used herein, includes promotional codes, discount codes, key codes, voucher codes, reward codes and so forth. Typically, Internet coupons provide for reduced cost or free shipping, a specific dollar or percentage discount, or some other offer to encourage consumers to purchase specific products or to purchase from specific retailers.

Coupon codes though only last for a particular period of time. Consumers with coupon codes to tender often do not know if they are valid until they attempt to purchase the product(s) at a merchant's website. For example, a consumer would typically select the product(s) the consumer desires to purchase on the merchant's website and later proceed to the checkout stage to purchase the selected product(s). At the checkout stage, the consumer may be provided with an option to enter a coupon code to receive a type of discount (e.g., free shipping, a percentage off the total cost of the purchase). If the user enters an invalid or expired coupon code, then the consumer will not be able to receive a discount. This negative experience may cause the consumer to have a negative opinion of the coupon provider as well as the merchant.

In addition to consumers experiencing frustration with using invalid or expired electronic coupon codes, merchants may generate bad will or attract bad publicity for failing to honor these expired coupon codes. Alternatively, merchants may lose profits if they do honor expired or invalid coupons.

In an attempt to address consumer frustration and potential bad publicity or lost profits for the merchant, websites, such as CouponCabin™, have been developed to provide coupon codes that are allegedly valid. However, the coupon codes that are provided by CouponCabin™ are manually checked as described above which is time-consuming, inefficient and prone to errors.

Other websites, such as RetailMeNot™, have been developed to provide a rate of success for using various coupon codes. Customers may vote or provide feedback as to whether a particular coupon code was valid and provided the advertised benefit. A percentage of success may be tallied based on the percentage of customers who had success using that coupon code. However, these percentages do not provide any indication as to the actual number of customers who have attempted to use the coupon code. For example, a 100% failure rate could be based on one person who tried to use the coupon code, but it failed for reasons other than the coupon code being expired. Furthermore, these percentages do not indicate when these coupon codes expire. Hence, a coupon code may have a high success rate; however, it may no longer be valid. For example, the success rate may be based on customers who used the coupon code while the coupon code was valid. Hence, when a customer attempts to use the coupon code with a high success rate after it becomes expired, the customer may become disappointed since the customer expected the coupon code to work.

Furthermore, these customers that vote or provide feedback as to whether a particular coupon code is valid and provided the advertised benefit have to manually select the product(s) the customer desires to purchase on the merchant's website and later proceed to the checkout stage to purchase the selected product(s) in order to determine if the coupon code is valid. Such a process is time consuming, inefficient and prone to human error (e.g., coupon failed for reasons other than the coupon code being expired).

Therefore, there is a need in the art for more accurately determining the validity of coupon codes in a more efficient manner.

### BRIEF SUMMARY OF THE INVENTION

In one embodiment of the present invention, a computer program product embodied in a computer readable storage medium for testing the validity of a coupon code comprises the programming step of receiving the coupon code. The computer program product further comprises the programming step of selecting one or more products on a merchant's website. Additionally, the computer program product comprises the programming step of adding the selected one or more products to a shopping cart. In addition, the computer program product comprises the programming step of entering a checkout stage on the merchant's website. Furthermore, the computer program product comprises the programming step of submitting the coupon code at the checkout stage of the merchant's website. The computer program product further comprises the programming step of determining if the coupon code is valid based on a status of the coupon code returned by the merchant's website.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWING

A better understanding of the present invention can be obtained when the following detailed description is considered in conjunction with the following drawings, in which:

FIG. 1 illustrates an embodiment of the present invention of a network system;

FIG. 2 illustrates an embodiment of the present invention of an evaluator;

FIG. 3 a flowchart of a method for testing the validity of coupon codes in accordance with an embodiment of the present invention;

FIG. 4 is a screenshot of selecting a product on a merchant website in accordance with an embodiment of the present invention;

FIG. 5 is a screenshot of adding the selected product to the shopping cart in accordance with an embodiment of the present invention;

FIG. 6 is a screenshot of entering a coupon code in the appropriate field at the checkout stage of the merchant's website in accordance with an embodiment of the present invention;

FIG. 7 is a screenshot at the checkout stage of the merchant's website indicating that the coupon code is invalid in accordance with an embodiment of the present invention; and

FIG. 8 is an illustrative report on the testing of the validity of multiple coupon codes on multiple merchant websites in accordance with an embodiment of the present invention.

### DETAILED DESCRIPTION OF THE INVENTION

The present invention comprises a system and computer program product for testing the validity of a coupon code. Coupon codes can be automatically tested, instead of manually testing them, by having a program select one or more products on a merchant's website and then add them to the shopping cart on the merchant's website. Upon entering the checkout stage on the merchant's website, the program can submit the coupon code to be tested at the checkout stage. The validity of the coupon code is determined based on the status of the coupon code (e.g., expired, approved advertised benefit) returned by the merchant's website. By having a program automatically test coupon codes instead of having a user manually test each coupon code, the validity of coupon codes can be more accurately determined in a more efficient manner.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

As stated in the Background section, currently, consumers may experience frustration with using invalid or expired electronic coupon codes. Furthermore, merchants may generate bad will or attract bad publicity for failing to honor these expired coupon codes. Alternatively, merchants may lose profits if they do honor expired or invalid coupons. While websites have been developed in an attempt to provide a rate of success for the use of various coupon codes, these are subject to human error and fail to accurately portray the validity of the coupon codes. Furthermore, the customers who provide feedback on these websites must partake in the time consuming and inefficient process of having to manually select the product(s) to purchase on the merchant's website and later proceed to the checkout stage to purchase the selected product(s) in order to determine if the coupon code is valid. Therefore, there is a need in the art for more accurately determining the validity of coupon codes in a more efficient manner.

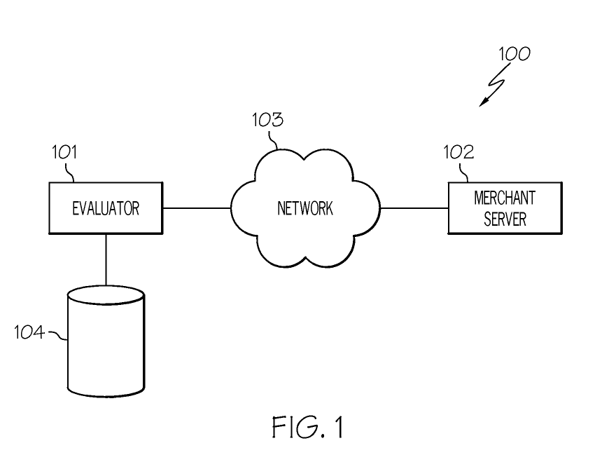

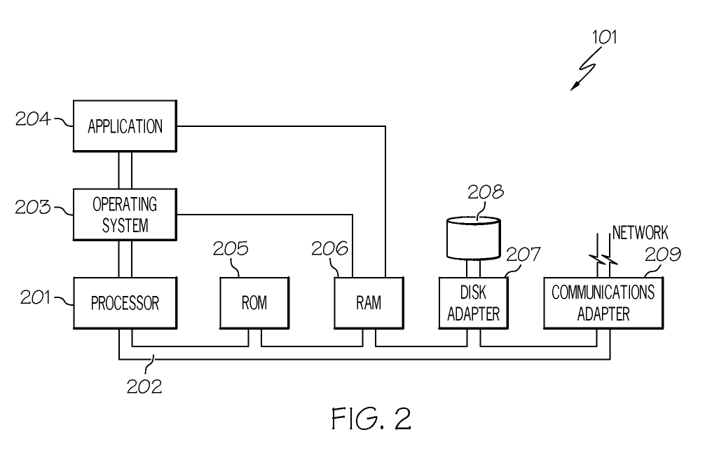

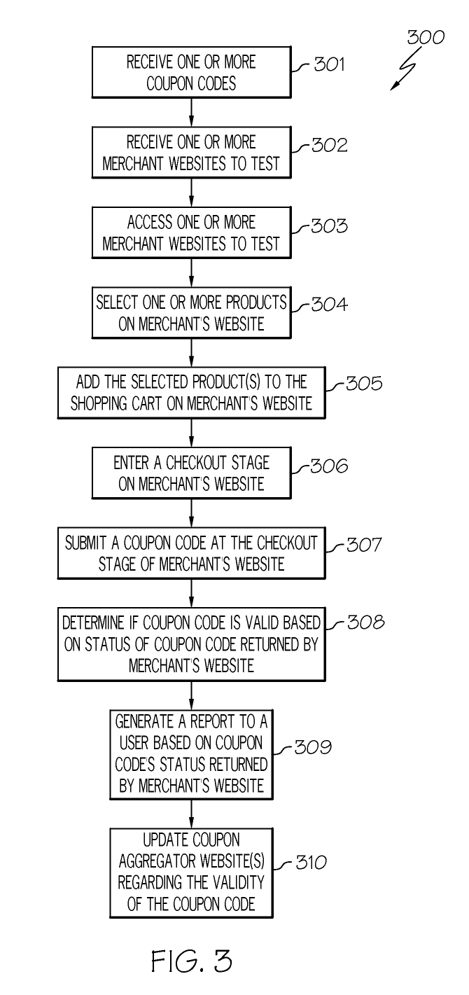

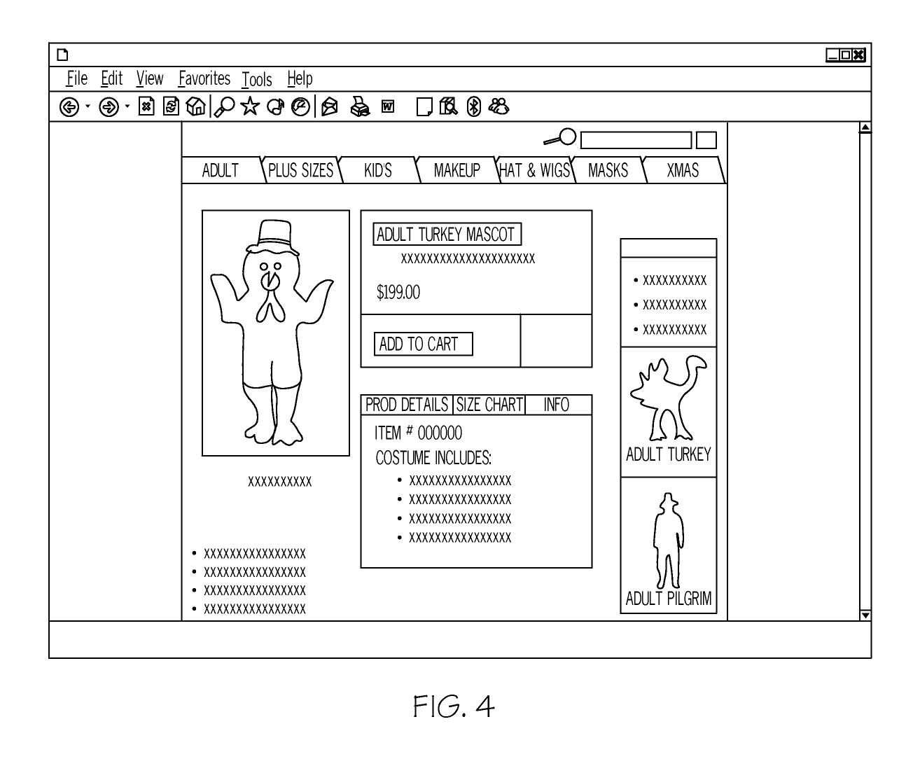

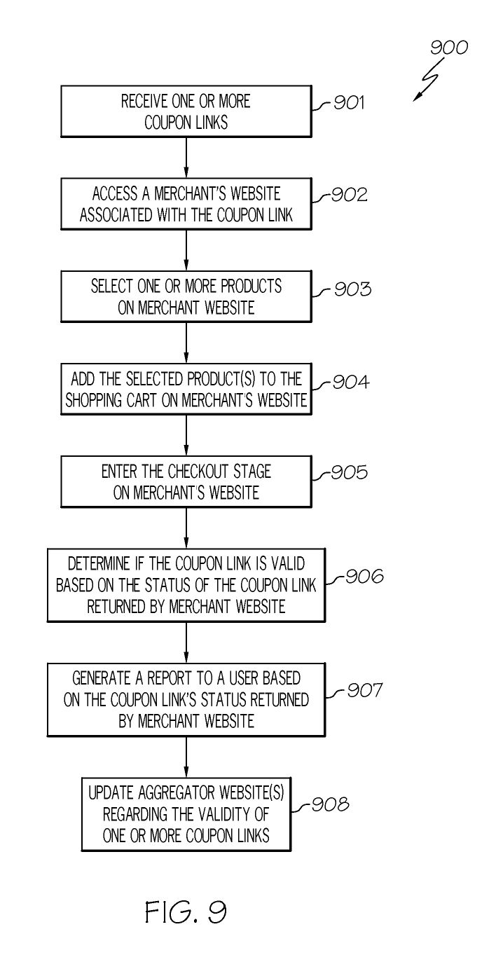

The principles of the present invention improve the accuracy and efficiency in testing the validity of coupon codes as discussed below in connection with FIGS. 1-8. FIG. 1 illustrates a network system for practicing the principles of the present invention. FIG. 2 illustrates an evaluator of the present invention. FIG. 3 is a flowchart of a method for testing the validity of the coupon codes. FIGS. 4-7, discussed in conjunction with FIG. 3, are screenshots showing various steps in the method for testing the validity of the coupon codes. FIG. 8, discussed in conjunction with FIG. 3, illustrates a report that may be generated depicting the results of testing the validity of multiple coupon codes on multiple merchant websites.

Additionally, the principles of the present invention may be applied to testing the validity of coupon links as discussed further below in conjunction with FIG. 9. FIG. 9 is a flowchart of a method for testing the validity of coupon links.

As discussed above, the principles of the present invention may be applied to a network system. Referring to FIG. 1, FIG. 1 illustrates a network system 100 in accordance with an embodiment of the present invention. Network system 100 may include a device referred to herein as the “evaluator” 101. Evaluator 101 is configured to test the validity of the coupon codes as discussed further below in connection with FIGS. 2-8. Furthermore, evaluator 101 is configured to test the validity of coupon links as discussed further below in connection with FIG. 9.

Network system 100 may further include a merchant server 102 configured to generate the website of a merchant (e.g., Best Buy™). Evaluator 101 may be connected to merchant sever 102 via network 103. Network 103 may refer to a Local Area Network (LAN) (e.g., Ethernet, Token Ring, ARCnet), or a Wide Area Network (WAN) (e.g., Internet).

Additionally, network system 100 may include a database 104 configured to store coupon codes and/or merchant websites to test. Coupon codes, as used herein, may refer to promotional codes, discount codes, key codes, voucher codes, reward codes and so forth.

FIG. 1 is not to be limited in scope to any particular embodiment and network system 100 may be any system that includes evaluator 101 and at least one merchant server 102.

An embodiment of the hardware configuration of evaluator 101 is discussed below in connection with FIG. 2.

FIG. 2 illustrates an embodiment of the hardware configuration of evaluator 101 (FIG. 1) which is representative of a hardware environment for practicing the present invention. Referring to FIG. 2, evaluator 101 may have a processor 201 coupled to various other components by system bus 202. An operating system 203 may run on processor 201 and provide control and coordinate the functions of the various components of FIG. 2. An application 204 in accordance with the principles of the present invention may run in conjunction with operating system 203 and provide calls to operating system 203 where the calls implement the various functions or services to be performed by application 204. Application 204 may include, for example, an application for testing the validity of coupon codes as discussed below in association with FIGS. 3-8. Application 204 may further include an application for testing the validity of coupon links as discussed below in association with FIG. 9.

Referring again to FIG. 2, read-only memory (“ROM”) 205 may be coupled to system bus 202 and include a basic input/output system (“BIOS”) that controls certain basic functions of evaluator 101. Random access memory (“RAM”) 206 and disk adapter 207 may also be coupled to system bus 202. It should be noted that software components including operating system 203 and application 204 may be loaded into RAM 206, which may be evaluator's 101 main memory for execution. Disk adapter 207 may be an integrated drive electronics (“IDE”) adapter that communicates with a disk unit 208, e.g., disk drive. It is noted that the program for testing the validity of coupon codes as discussed below in association with FIGS. 3-8, may reside in disk unit 208 or in application 204. Furthermore, it is noted that the program for testing the validity of coupon links as discussed below in association with FIG. 9, may reside in disk unit 208 or in application 204.

Evaluator 101 may further include a communications adapter 209 coupled to bus 202. Communications adapter 209 may interconnect bus 202 with an outside network, such as network 103 (FIG. 1) thereby allowing evaluator 101 to communicate with merchant server 102.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to product a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As discussed above, application 204 may include, for example, an application for testing the validity of coupon codes. A flowchart of a method for testing the validity of the coupon codes is discussed below in connection with FIG. 3.

FIG. 3 is a flowchart of a method 300 for testing the validity of coupon codes in accordance with an embodiment of the present invention.

Referring to FIG. 3, in conjunction with FIGS. 1-2, in step 301, evaluator 101 receives one or more coupon codes. In one embodiment, evaluator 101 obtains the coupon codes from database 104. In one embodiment, the coupon code may be associated with a particular merchant. As a result, the coupon code will be tested in connection with that particular merchant. However, if a coupon code can be used in combination with several merchants, then the coupon code may be tested in connection with those merchants.

Optionally, in step 302, evaluator 101 receives an indication of one or more merchant websites 102 (e.g., link to a merchant website) whose coupon codes are to be tested. In one embodiment, evaluator 101 obtains the merchant websites to test from database 104. For each merchant website, evaluator 101 may have one or more coupon codes (obtained in step 301) to test on that merchant website.

In step 303, evaluator 101 accesses one or more merchant websites 102 (e.g., www.bestbuy™.com). While the following steps of method 300 are discussed in connection with a single merchant website, it is noted that the principles of the present invention may implement the following steps of method 300 on multiple merchant websites concurrently (i.e., in parallel).

In step 304, evaluator 101 selects one or more products on merchant website 102 as illustrated in FIG. 4. FIG. 4 is a screenshot of selecting a product (e.g., adult turkey mascot outfit) on a merchant website (redacted for commercial sensitivity) in accordance with an embodiment of the present invention.

In one embodiment, evaluator 101 randomly selects one or more products on the merchant's website. In another embodiment, the product(s) selected may be in connection with the received coupon code. For example, if the coupon code provides a 20% discount based on the combined purchase of a Sony™ high definition television set and a Sony™ blue-ray disc player, then a Sony™ high definition television set and a Sony™ blue-ray disc player would be selected on the merchant's website.

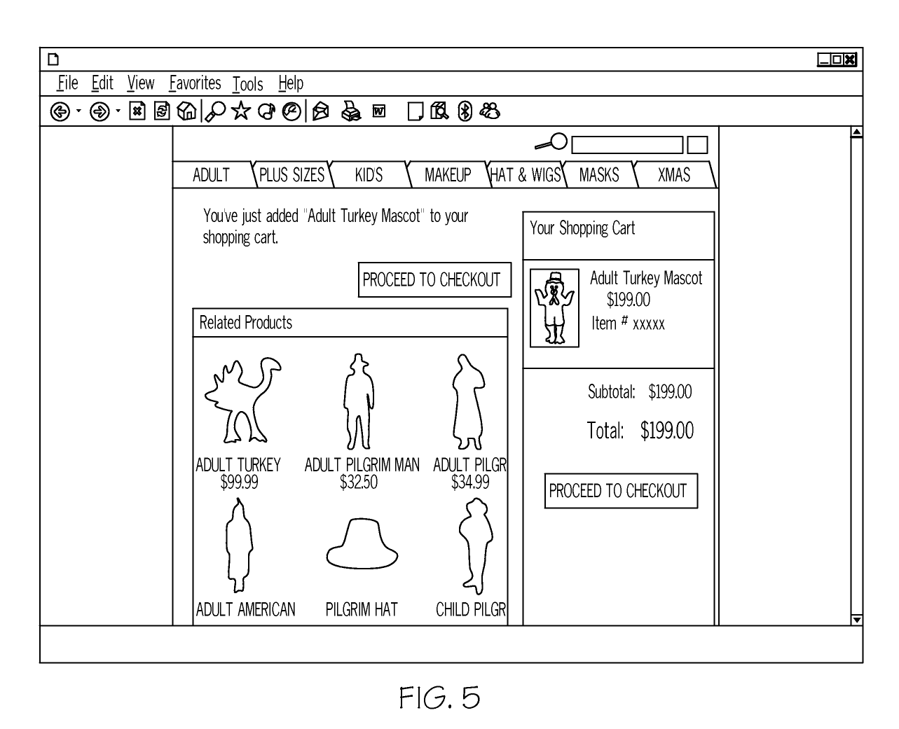

Returning to FIG. 3, in conjunction with FIGS. 1-2, in step 305, evaluator 101 adds the selected product(s) to the shopping cart on merchant's website 102 as illustrated in FIG. 5. FIG. 5 is a screenshot of adding the adult turkey mascot outfit to the shopping cart in accordance with an embodiment of the present invention.

In step 306, evaluator 101 enters the checkout stage on merchant's website 102.

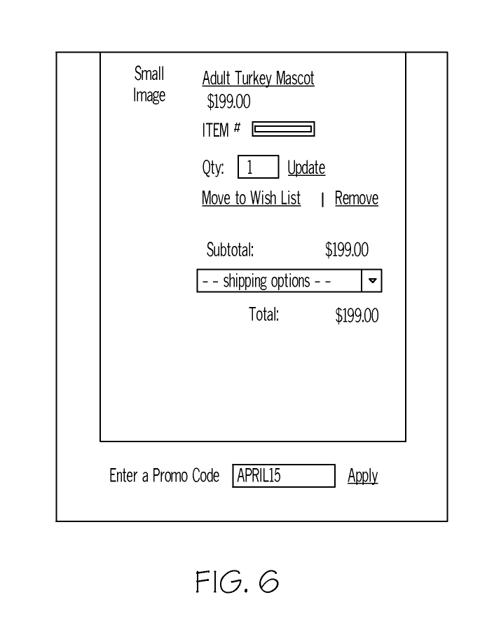

In step 307, evaluator 101 submits a coupon code at the checkout stage of merchant's website 102 as illustrated in FIG. 6. FIG. 6 is a screenshot of entering a coupon code (shown as a promotional code) in the appropriate field at the checkout stage of the merchant's website in accordance with an embodiment of the present invention.

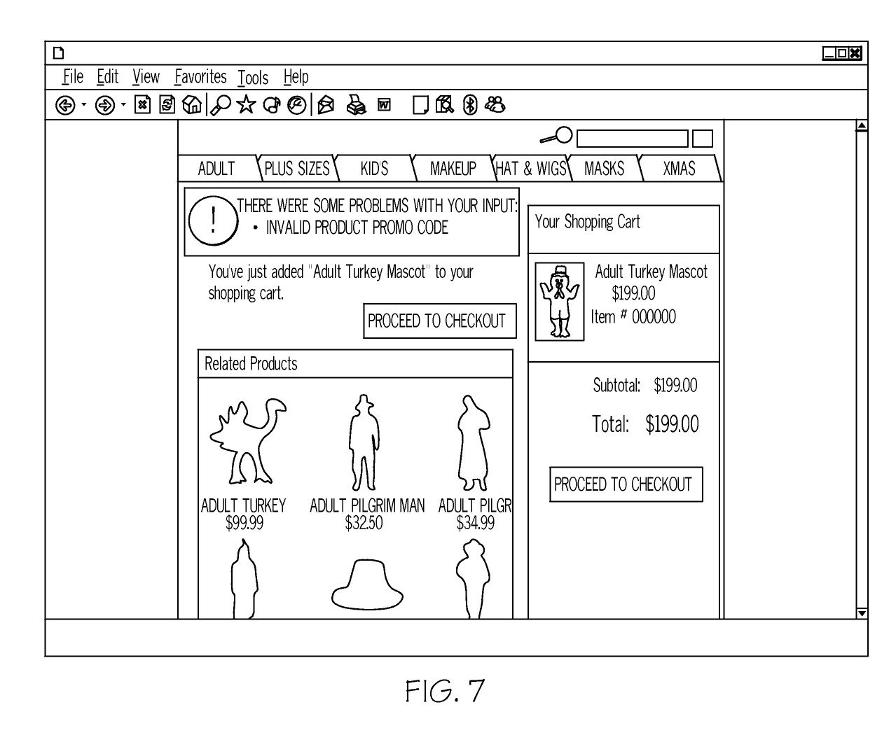

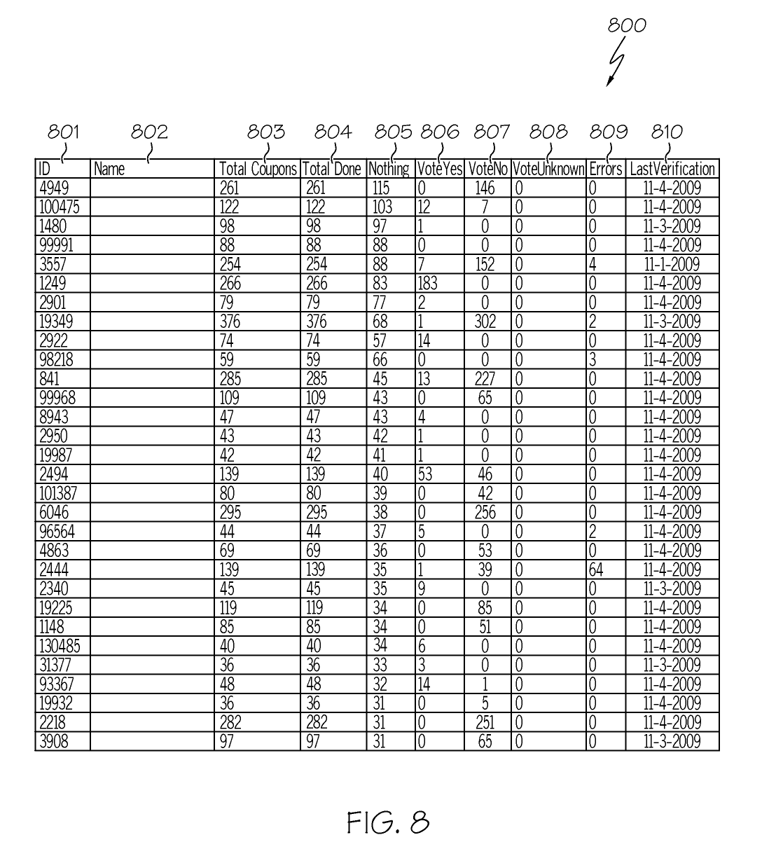

Returning to FIG. 3, in conjunction with FIGS. 1-2, in step 308, evaluator 101 determines if the coupon code is valid based on the status of the coupon code returned by merchant website 102. For example, merchant website 102 may indicate that the coupon code is invalid (e.g., expired) as illustrated in FIG. 7. FIG. 7 is a screenshot at the checkout stage of the merchant's website indicating that the coupon code is invalid in accordance with an embodiment of the present invention. In one embodiment, the status returned by merchant website 102 may indicate that the coupon code is valid by approving the advertised benefit (e.g., a discount is applied to the cost of the product(s) to be purchased as advertised by the electronic coupon). Furthermore, the status returned by merchant website 102 may indicate that the coupon code is invalid (e.g., expired) as illustrated in FIG. 7. Additionally, the status returned by merchant website 102 may indicate that there is an error. In addition, merchant website 102 may not provide any response, or in some cases, the status of the coupon code is indeterminate.

In step 309, evaluator 101 generates a report to a user based on the coupon code's status returned by merchant website 102. In one embodiment, evaluator 102 may test the validity of multiple coupon codes on multiple merchant websites 102. In such an embodiment, evaluator 102 may generate a report indicating the results of testing the validity of numerous coupon codes on multiple merchant websites 102 as illustrated in FIG. 8. FIG. 8 is an illustrative report on the testing of the validity of multiple coupon codes on multiple merchant websites 102 generated by evaluator 101 in accordance with an embodiment of the present invention.

Referring to FIG. 8, report 800 includes a column 801 of identifications (identified by “ID” in FIG. 8) that uniquely identifies a particular merchant. Column 802 (identified by “Name” in FIG. 8) includes a list of merchant websites (redacted for commercial sensitivity) that correspond to the identifications listed in column 801 for that particular row. Each row in report 800 contains information, as discussed further below, obtained from testing coupon codes for the particular merchant identified in columns 801, 802.

Referring again to FIG. 8, the total number of coupon codes to be tested is listed in column 803 (identified by “TotalCoupons” in FIG. 8). Column 804 (identified by “TotalDone” in FIG. 8) lists the total number of coupon codes that were actually tested. The results of the test are shown in columns 805-809. Column 805 (identified by “Nothing” in FIG. 8) refers to the number of times merchant website 102 failed to provide a response that could be interpreted. Column 806 (identified by “VoteYes” in FIG. 8) refers to the number of coupon codes (out of the total number of coupon codes to be tested) that were successfully implemented. Column 807 (identified by “VoteNo” in FIG. 8) refers to the number of coupon codes (out of the total number of coupon codes to be tested) that were invalid. Column 808 (identified by “VoteUnkown” in FIG. 8) refers to the number of coupon codes (out of the total number of coupon codes to be tested) that were deemed to be indeterminate. Column 809 (identified by “Errors” in FIG. 8) refers to the number of errors received out of the total number of coupon codes that were tested. Column 810 (identified by “LastVerification” in FIG. 8) refers to the time that the coupon codes were tested for that particular merchant.

For example, referring to FIG. 8, for the merchant identified by the identification number of 100475, evaluator 101 tested a total of 122 coupon codes. Out of those coupon codes, 12 were tested valid and 7 were tested to be invalid. A further 103 coupon codes could not be determined to be either valid or not valid since a response was not received from the merchant website.

As illustrated in FIG. 8, multiple coupon codes may be tested for multiple merchants. The testing of the coupon codes for each merchant may be performed in parallel or in series.

Returning to FIG. 3, in conjunction with FIGS. 1-2, in step 310, evaluator 101 may optionally update an aggregator website(s) (a website containing a list of coupon codes/coupon links) regarding the validity of one or more coupon codes listed on the aggregator website(s). Updating may include removing the coupon code(s) from the aggregator website as well as replenishing (i.e., reiterating the validity) the coupon code(s) from the aggregator website. It is noted that evaluator 101 may update multiple aggregator websites concurrently.

Method 300 may include other and/or additional steps that, for clarity, are not depicted. Further, method 300 may be executed in a different order presented and that the order presented in the discussion of FIG. 3 is illustrative. Additionally, certain steps in method 300 may be executed in a substantially simultaneous manner or may be omitted.

As discussed above, application 204 may further include, for example, an application for testing the validity of coupon links (e.g., uniform resource locator) that activate a discount. A flowchart of a method for testing the validity of coupon links is discussed below in connection with FIG. 9.

Referring to FIG. 9, in conjunction with FIGS. 1-2, in step 901, evaluator 101 receives one or more coupon links. In one embodiment, evaluator 101 obtains the coupon links from database 104. A coupon link may refer to a uniform resource locator that activates a discount (e.g., 10% off plasma television sets).

In step 902, evaluator 101 accesses a merchant's website 102 associated with the coupon link.

In step 903, evaluator 101 selects one or more products on merchant website 102 as illustrated in FIG. 4. In one embodiment, evaluator 101 randomly selects one or more products on the merchant's website. In another embodiment, the product(s) selected may be in connection with the received coupon link. For example, if the coupon link provides a 10% discount for the purchase of a plasma television set, then a plasma television set may be selected.

Returning to FIG. 9, in conjunction with FIGS. 1-2, in step 904, evaluator 101 adds the selected product(s) to the shopping cart on merchant's website 102 as illustrated in FIG. 5.

Returning again to FIG. 9, in conjunction with FIGS. 1-2, in step 905, evaluator 101 enters the checkout stage on merchant's website 102.

In step 906, evaluator 101 determines if the coupon link is valid based on the status of the coupon link returned by merchant website 102. For example, the status returned by merchant website 102 may indicate that the coupon link is valid by applying the discount (e.g., 10% off plasma television sets). Other statuses that may be returned by merchant website 102 are discussed above in connection with method 300 and will not be reproduced for the sake of brevity.

In step 907, evaluator 101 generates a report to a user based on the coupon link's status returned by merchant website 102. A detail description of evaluator 101 generating a report was discussed above in connection with method 300 and will not be reproduced for the sake of brevity.

In step 908, evaluator 101 may optionally update an aggregator website(s) (a website containing a list of coupon codes/coupon links) regarding the validity of one or more coupon links listed on the aggregator website(s). A detail description of evaluator 101 updating an aggregator website was discussed above in connection with method 300 and will not be reproduced for the sake of brevity.

Method 900 may include other and/or additional steps that, for clarity, are not depicted. Further, method 900 may be executed in a different order presented and that the order presented in the discussion of FIG. 9 is illustrative. Additionally, certain steps in method 900 may be executed in a substantially simultaneous manner or may be omitted.

Although the system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

1. A computer program product embodied in a computer readable storage medium for testing the validity of a coupon code, the computer program product comprising the programming instructions for:
receiving said coupon code;
selecting one or more products on a merchant's website;
adding said selected one or more products to a shopping cart;
entering a checkout stage on said merchant's website;
submitting said coupon code at said checkout stage of said merchant's website; and
determining if said coupon code is valid based on a status of said coupon code returned by said merchant's website.

2. The computer program product as recited in claim 1 further comprising the programming instructions for:
receiving an identification of said merchant's website.

3. The computer program product as recited in claim 1, wherein said one or more products are selected at random on said merchant's website.

4. The computer program product as recited in claim 1 further comprising the programming instructions for:
generating a report to a user based on said status of said coupon code returned by said merchant's website.

5. The computer program product as recited in claim 1, wherein said status of said coupon code returned comprises an expiration indication.

6. The computer program product as recited in claim 1, wherein said status of said coupon code returned comprises a validation indication.

7. The computer program product as recited in claim 1 further comprising the programming instructions for:
updating one or more coupon aggregator websites regarding the validity of said coupon code.

8. The computer program product as recited in claim 7, wherein said updating comprises removing said coupon code from said one or more coupon aggregator websites.

9. The computer program product as recited in claim 7, wherein said updating comprises replenishing said coupon code at said one or more coupon aggregator websites.

10. A system, comprising:
a memory unit for storing a computer program for testing the validity of a coupon code; and
a processor coupled to said memory unit, wherein said processor, responsive to said computer program, comprises:
circuitry for receiving said coupon code;
circuitry for selecting one or more products on a merchant's website;
circuitry for adding said selected one or more products to a shopping cart;
circuitry for entering a checkout stage on said merchant's website;
circuitry for submitting said coupon code at said checkout stage of said merchant's website; and
circuitry for determining if said coupon code is valid based on a status of said coupon code returned by said merchant's website.

11. The system as recited in claim 10, wherein said processor further comprises:
circuitry for receiving an identification of said merchant's website.

12. The system as recited in claim 10, wherein said one or more products are selected at random on said merchant's website.

13. The system as recited in claim 10, wherein said processor further comprises:
circuitry for generating a report to a user based on said status of said coupon code returned by said merchant's website.

14. The system as recited in claim 10, wherein said status of said coupon code returned comprises an expiration indication.

15. The system as recited in claim 10, wherein said status of said coupon code returned comprises a validation indication.

16. The system as recited in claim 10, wherein said processor further comprises:
circuitry for updating one or more coupon aggregator websites regarding the validity of said coupon code.

17. The system as recited in claim 16, wherein said updating comprises removing said coupon code from said one or more coupon aggregator websites.

18. The system as recited in claim 16, wherein said updating comprises replenishing said coupon code at said one or more coupon aggregator websites.

19. A computer program product embodied in a computer readable storage medium for testing the validity of a coupon link, the computer program product comprising the programming instructions for:
receiving said coupon link;
activating said coupon link to access a merchant's website;
selecting one or more products on said merchant's website;
adding said selected one or more products to a shopping cart;
entering a checkout stage on said merchant's website; and
determining if said coupon link is valid based on a status of said coupon link returned by said merchant's website.

20. A system, comprising:
a memory unit for storing a computer program for testing the validity of a coupon link; and
a processor coupled to said memory unit, wherein said processor, responsive to said computer program, comprises:
circuitry for receiving said coupon link;
circuitry for activating said coupon link to access a merchant's website;
circuitry for selecting one or more products on said merchant's website;
circuitry for adding said selected one or more products to a shopping cart;
circuitry for entering a checkout stage on said merchant's website; and
circuitry for determining if said coupon link is valid based on a status of said coupon link returned by said merchant's website.
